(19) United States
(12) Patent Application Publication
(10) Pub. No.: US 2013/0172010 A1
(43) Pub. Date: Jul. 4, 2013

(54) METHOD FOR GENERATING IN-BUILDING PROPAGATION ENVIRONMENT MAPS AND DEVICE THEREFOR

(71) Applicants: Suk Yon Kang, Seoul (KR); Chae Hwan Cho, Gyeonggi-do (KR); Seung Yoon Baek, Seoul (KR); Hye Min Lee, Gyeonggi-Do (KR); Chang Seok Lee, Seoul (KR)

(72) Inventors: Suk Yon Kang, Seoul (KR); Chae Hwan Cho, Gyeonggi-do (KR); Seung Yoon Baek, Seoul (KR); Hye Min Lee, Gyeonggi-Do (KR); Chang Seok Lee, Seoul (KR)

(73) Assignee: SK TELECOM CO., LTD., Seoul (KR)

(21) Appl. No.: 13/806,959

(22) PCT Filed: Jun. 27, 2011
(86) PCT No.: PCT/KR11/04654

§ 371 Date: Mar. 14, 2013

(30) Foreign Application Priority Data
Jun. 25, 2010 (KR) 10-2010-0060674

(51) Int. Cl. H04W 4/04

(52) U.S. Cl. CPC H04W 4/043
USPC 455/456.1

(57) ABSTRACT

An apparatus for generating in-building radiowave environment maps, includes: an in-building map providing unit configured to provide in-building map data to a radiowave measurement device; a reference point setting unit configured to interwork with the radiowave measurement device and set up a reference point of specific area in the in-building map data; a location estimating unit configured to estimate a mobile location of the radiowave measurement device by using motion sensor information received from the radiowave measurement device; a radiowave environment collecting unit configured to collect radiowave environment information from the radiowave measurement device; and an in-building radiowave environment mapping unit configured to generate an in-building radiowave environment map by storing the radiowave environment information onto the in-building map data matchingly with every piece of location estimation information on the mobile location estimated based on the reference point.

### TECHNICAL FIELD

The present disclosure relates in some aspects to a method for generating in-building radiowave environment maps and an apparatus therefor. More particularly, the present disclosure concerns in-building radiowave environment maps yet to be built in new buildings or underground shopping malls but required to determine user locations in those venues, which are shadow regions where global positioning system (GPS) radiowave signals are not received, and relates to a method and apparatus for generating in-building radiowave environment maps, which are capable of estimating a mobile location by using a radiowave measurement apparatus mounted with a motion sensor, and generating in-building radiowave environment maps matched with radiowave environment characteristics at every estimated location.

### BACKGROUND

The statements in this section merely provide background information related to the present disclosure and may not constitute prior art.

With the rapid development of computer, electronic and communication technologies, a variety of wireless communication services involving wireless networks have been provided. Accordingly, services provided by mobile communication systems involving wireless communication networks have evolved from voice services to multimedia services that involve transmission of circuit data, packet data, and the like.

Among a variety of wireless Internet services using mobile communication terminals, a location based service (LBS) has attracted much attention due to its wide applications and convenience. An LBS refers to a communication service that determines a location of a mobile communication terminal, such as a portable phone and a personal digital assistant (PDA), and provides additional information related to the determined location. Location determination technologies for providing an LBS may be classified into a network based scheme, a handset based scheme, and a hybrid scheme. Specifically, the network based scheme checks a location by using radiowave environments by way of software, which are a cell radius of a base station in a mobile communication network, in order to determine a location of a mobile communication terminal. The handset based scheme uses a GPS receiver mounted on a mobile communication terminal in order to determine a location of the mobile communication terminal. The hybrid scheme is a combination of the network based scheme and the handset based scheme.

Meanwhile, in the case of a location determination system using GPS radiowave signals, an accurate location determination may be achieved by using GPS radiowave signals outdoors. However, when a user enters an underground shopping mall or a building where a GPS radiowave signal is not received, a normal location determination may not be achieved. In addition, since underground shopping malls or large shopping malls tend to increase, there is a need for establishing radiowave environment maps for in-building areas in order to accurately determine locations even in an in-building environment.

### DISCLOSURE

### Technical Problem

In order to solve the above-described problems, the present disclosure concerns in-building radiowave environment maps yet to be built in new buildings or underground shopping malls and one or more embodiments of the present disclosure are directed to provide a method and apparatus for generating in-building radiowave environment maps, which are capable of estimating a mobile location by using a radiowave measurement apparatus mounted with a motion sensor, and generating in-building radiowave environment maps matched with radiowave environment characteristics at every estimated location.

### Summary

An embodiment of the present disclosure provides an apparatus for generating in-building radiowave environment maps, including: an in-building map providing unit configured to provide in-building map data to a radiowave measurement device; a reference point setting unit configured to interwork with the radiowave measurement device and set up a reference point of specific area in the in-building map data; a location estimating unit configured to estimate a mobile location of the radiowave measurement device by using motion sensor information received from the radiowave measurement device; a radiowave environment collecting unit configured to collect radiowave environment information from the radiowave measurement device; and an in-building radiowave environment mapping unit configured to generate an in-building radiowave environment map by storing the radiowave environment information onto the in-building map data matchingly with every piece of location estimation information for representing the mobile location estimated based on the reference point.

Another embodiment of the present disclosure provides a method for generating in-building radiowave environment maps, including: providing in-building map data to a radiowave measurement device; interworking with the radiowave measurement device and setting up a reference point of specific area in the in-building map data; estimating a mobile location of the radiowave measurement device by using motion sensor information received from the radiowave measurement device; collecting radiowave environment information from the radiowave measurement device; and generating an in-building radiowave environment map by storing the radiowave environment information onto the in-building map data matchingly with every piece of location estimation information for representing the mobile location estimated based on the reference point.

### Advantageous Effects

According to the present disclosure as described above, since in-building radiowave environment maps for new-built buildings or underground shopping malls are not yet established at present, a mobile location can be estimated by using a radiowave measurement apparatus mounted with a motion sensor, and in-building radiowave environment maps matched with radiowave environment characteristics can be generated at every estimated location. Moreover, more accurate in-building radiowave environment maps can be generated by mutually matching a reference point on in-building map data stored in an in-building radiowave environment mapping apparatus and a reference point on in-building map data stored in a radiowave measurement apparatus, as the same location information.

### DESCRIPTION OF DRAWINGS

FIG. 1 is a block diagram schematically showing a system for generating in-building radiowave environment maps according to one embodiment of the present disclosure;

FIG. 2 is a block diagram schematically showing an in-building radiowave environment mapping apparatus according to one embodiment of the present disclosure;

FIG. 3 is a block diagram schematically showing a radiowave measurement apparatus according to one embodiment of the present disclosure;

FIG. 4 is a flow chart showing a radiowave environment measurement method according to one embodiment of the present disclosure;

FIG. 5 is a flow chart showing an in-building radiowave environment mapping method according to one embodiment of the present disclosure; and

FIG. 6 is an exemplary diagram of an in-building radiowave environment map according to one embodiment of the present disclosure.

<Description of Reference Numerals>

110: Radiowave Measurement Apparatus
120: In-building Radiowave Environment Mapping Apparatus
210: In-building Map Providing Unit
220: First Reference Point Setting Unit
230: Location Estimating Unit
240: Radiowave Environment Collecting Unit
250: In-building Radiowave Environment Mapping Unit
260: Database
310: In-building Map Receiving Unit
320: Second Reference Point Setting Unit
330: Motion Sensor Information Transmitting Unit
340: Radiowave Environment Transmitting Unit
350: Radiowave Environment Outputting Unit

### DETAILED DESCRIPTION

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

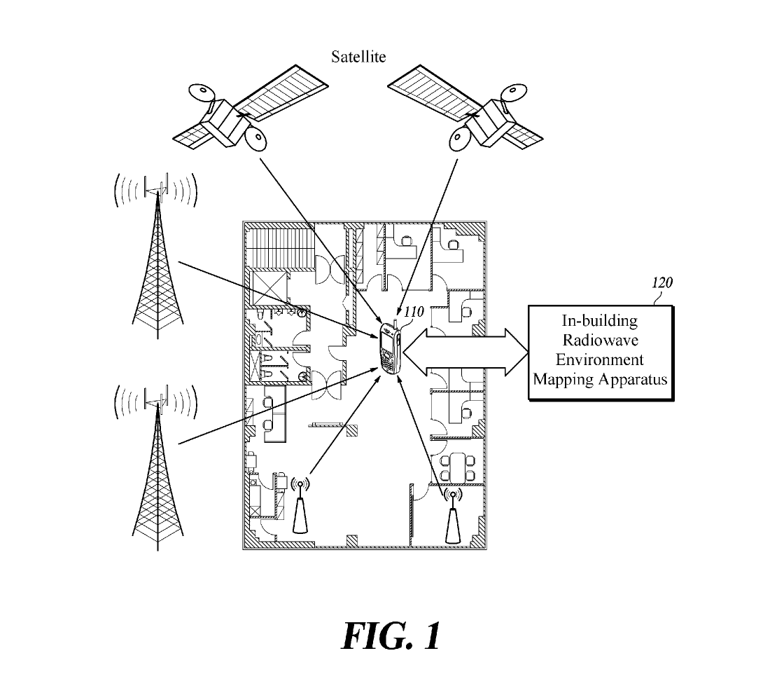

FIG. 1 is a block diagram schematically showing a system for generating in-building radiowave environment maps according to one embodiment of the present disclosure.

A system for generating in-building radiowave environment maps according to one embodiment of the present disclosure includes a radiowave measurement apparatus 110 and an in-building radiowave environment mapping apparatus 120. Meanwhile, the system for generating in-building radiowave environment maps according to one embodiment of the present disclosure is described as including only the radiowave measurement apparatus 110 and the in-building radiowave environment mapping apparatus 120, but this is merely an exemplary description about the technical spirit of one embodiment of the present disclosure. It is apparent to those skilled in the art that elements included in the system for generating in-building radiowave environment maps can be modified and changed in various forms, without departing from essential characteristics of one embodiment of the present disclosure.

The radiowave measurement apparatus 110 may be a terminal including a wireless communication module for performing a typical voice call and data communication, but is not necessarily limited thereto. That is, the radiowave measurement apparatus 110 may be implemented with a separate device for measuring radiowaves, excluding a typical voice call. The radiowave measurement apparatus 110 interworks with a mobile communication network (not shown) using a wireless communication module and performs a typical voice call and data communication through wireless communication. The radiowave measurement apparatus 110 transmits base station information of the interworking mobile communication network to the in-building radiowave environment mapping apparatus 120.

In addition, the radiowave measurement apparatus 110 is a terminal mounted with a wireless LAN module and is a terminal that can connect to an Internet network through a detected adjacent access point (AP) by using the mounted wireless LAN module and receive a variety of webpage data. The AP refers to a device for connecting data communication. Specifically, the AP refers to a device that can read an address of a receiving side from information of a transmitting side, designate an optimal communication path, and transmit data to other communication network. That is, the AP may extract a position of a data packet, designate an optimal communication path with respect to the extracted position of the data packet, transmit the data packet to other device through the designated communication path, and share a plurality of communication lines under the general network environment. In this embodiment, the AP may be used as a concept encompassing a router, a repeater, a relay, and a bridge.

In addition, the radiowave measurement apparatus 110 is a terminal mounted with a GPS module. The radiowave measurement apparatus 110 extracts navigation data from GPS radiowave signals received from one or more GPS satellites, and transmits the extracted navigation data to the in-building radiowave environment mapping apparatus 120 through the mobile communication network. The radiowave measurement apparatus 110 according to one embodiment of the present disclosure may be mounted with the GPS module, but is not necessarily limited thereto.

The radiowave measurement apparatus 110 may be any one of a smart phone, a personal computer (PC), a notebook computer, and a personal digital assistant (PDA), each of which is mounted with a wireless communication module, a GPS module, and a wireless LAN module. The radiowave measurement apparatus 110 refers to a terminal that includes a memory for storing an application for use in LBS, a microprocessor for executing a program to effect computing and controlling, and the like.

The radiowave measurement apparatus 110 serving as the external server according to one embodiment of the present disclosure downloads in-building map data from the in-building radiowave environment mapping apparatus 120 serving as an external server, and installs the downloaded in-building map data. In addition, the radiowave measurement apparatus 110 interworks with the in-building radiowave environment mapping apparatus 120 serving as the external server and sets up a specific area of the in-building map data as a reference point. When a GPS satellite is detected, the radiowave measurement apparatus 110 sets up current location information, which is obtained based on a GPS radiowave signal received from the GPS satellite, in the in-building map data as the reference point, and transmits the set reference point to the in-building radiowave environment mapping apparatus 120 serving as the external server. That is, the radiowave measurement apparatus 110 mutually matches the reference point on the in-building map data stored in the in-building radiowave environment mapping apparatus 120 and the reference point on the in-building map data stored in the radiowave measurement apparatus 110, as the current location information obtained based on the GPS radiowave signal representing the same location information. For example, since the radiowave measurement apparatus 110 is located in the in-building area, it is expected that the received GPS radiowave signal will be weak. However, even in the in-building area, the GPS radiowave signal may be received at locations near windows or outer walls. Therefore, when the GPS radiowave signal is received in the in-building area, it is determined that a current location based on the GPS radiowave signal is an exact location, and the corresponding location may be shared as the reference point between the radiowave measurement apparatus 110 and the in-building radiowave environment mapping apparatus 120.

In addition, the radiowave measurement apparatus 110 sets up location information, which corresponds to a selection signal of specific area, as the reference point having coordinates of (0, 0), and transmits the set reference point to the in-building radiowave environment mapping apparatus 120 serving as the external server. That is, the radiowave measurement apparatus 110 mutually matches the reference point on the in-building map data, which is stored in the in-building radiowave environment mapping apparatus 120, and the reference point on the in-building map data, which is stored in the radiowave measurement apparatus 110, as the location information corresponding to the selection signal of specific area representing the same location information. Although it has been described that the reference point on the in-building map data stored in the in-building radiowave environment mapping apparatus 120 and the reference point on the in-building map data stored in the radiowave measurement apparatus 110 are mutually matched through the radiowave measurement apparatus 110, this is merely one embodiment of the present disclosure. In the actual implementation of the present disclosure, it should be understood conceptually that the reference point on the in-building map data stored in the in-building radiowave environment mapping apparatus 120 and the reference point on the in-building map data stored in the radiowave measurement apparatus 110 are mutually matched through the interworking between the in-building radiowave environment mapping apparatus 120 and the radiowave measurement apparatus 110. In addition, after receiving the coordinates of (0, 0) as the location information, the in-building radiowave environment mapping apparatus 120 serving as the external server may convert the reference point into general GPS coordinates and store the GPG coordinates in the in-building map data by matching therewith.

In addition, the radiowave measurement apparatus 110 transmits motion sensor information, which is collected by using the motion sensor mounted thereon, to the in-building radiowave environment mapping apparatus 120 serving as the external server. The motion sensor is a sensor for detecting user motion, and the motion sensor mounted on the radiowave measurement apparatus 110 may include one or more modules among a gyro sensor, a geomagnetic sensor, a digital compass, and an acceleration sensor. In addition, the radiowave measurement apparatus 110 transmits radiowave environment information, which is received from adjacent communicating devices, to the in-building radiowave environment mapping apparatus 120 serving as the external server. The radiowave measurement apparatus 110 transmits the radiowave environment information, including base station-derived information and/or wireless LAN signals from the adjacent communicating devices, to the in-building radiowave environment mapping apparatus 120 serving as the external server. The radiowave measurement apparatus 110 overlays the motion sensor information and/or the radiowave environment information on the in-building map data for displaying.

The in-building radiowave environment mapping apparatus 120 according to one embodiment of the present disclosure provides the in-building map data to the radiowave measurement apparatus 110. The in-building radiowave environment mapping apparatus 120 extracts an in-building map of a specific location requested by the radiowave measurement apparatus 110 from an in-building map DB, and transmits the extracted in-building map to the radiowave measurement apparatus 110.

The in-building radiowave environment mapping apparatus 120 interworks with the radiowave measurement apparatus 110 and sets up a reference point of specific area in the in-building map data. When the radiowave measurement apparatus 110 detects a GPS satellite, the in-building radiowave environment mapping apparatus 120 sets up current location information, which is obtained based on a GPS radiowave signal received through the GPS satellite, in the in-building map data as the reference point, and transmits the set reference point to the radiowave measurement apparatus 110.

That is, the reference point on the in-building map data stored in the in-building radiowave environment mapping apparatus 120 and the reference point on the in-building map data stored in the radiowave measurement apparatus 110 are mutually matched as the current location information obtained based on the GPS radiowave signal representing the same location information. In addition, the in-building radiowave environment mapping apparatus 120 sets up a reference point from location information which corresponds to a selection signal of specific area received from the radiowave measurement apparatus 110, and sets up the coordinates of the reference point to (0, 0). In other words, the reference point on the in-building map data stored in the in-building radiowave environment mapping apparatus 120 and the reference point on the in-building map data stored in the radiowave measurement apparatus 110 are mutually matched as the location information corresponding to the received selection signal of specific area representing the same location information. Although it has been described that the reference point on the in-building map data in the in-building radiowave environment mapping apparatus 120 and the reference point on the in-building map data in the radiowave measurement apparatus 110 are mutually matched through the in-building radiowave environment mapping apparatus 120, this is merely one of many embodiments of the present disclosure. In the actual implementation of the present disclosure, it should be understood conceptually that the reference point on the in-building map data stored in the in-building radiowave environment mapping apparatus 120, and the reference point on the in-building map data stored in the radiowave measurement apparatus 110, are mutually matched through the interworking between the in-building radiowave environment mapping apparatus 120 and the radiowave measurement apparatus 110.

The in-building radiowave environment mapping apparatus 120 generates location estimation information from estimating a mobile location of the radiowave measurement apparatus 110 by using the motion sensor information received from the radiowave measurement apparatus 110. The in-building radiowave environment mapping apparatus 120 estimates information on a moving distance and direction per second of the radiowave measurement apparatus 110, based on direction information and/or acceleration information included in the motion sensor information.

The in-building radiowave environment mapping apparatus 120 collects the radiowave environment information from the radiowave measurement apparatus 110. The in-building radiowave environment mapping apparatus 120 collects the radiowave environment information, including base station-derived information on base stations with which the radiowave measurement apparatus 110 communicates, from the radiowave measurement apparatus 110. The base station-derived information includes at least one of system ID (SID), network ID (NID), base station ID (BSID), base station sector number (Ref_PN: reference PN), received signal strength indicator (RSSI), signal-to-noise ratio (Ec/lo), and phase information. The in-building radiowave environment mapping apparatus 120 divides the in-building map data into grids, stores the base station-derived information in the grids by matching therewith, and assigns identification information to each of the grids in order to distinguish the respective grids from one another. In addition, the in-building radiowave environment mapping apparatus 120 collects the radiowave environment information, including wireless LAN signals detected by the radiowave measurement apparatus 110, from the radiowave measurement apparatus 110. The wireless LAN signal includes at least one of Wi-Fi signals, WiMax signals, delivery traffic indication messages (DTIM), and hot spot signals. The wireless LAN signal includes at least one of MAC address of access point (AP) relaying the wireless LAN signal, received signal strength (RSS) of each MAC address, AP channel information, and AP frequency information. The in-building radiowave environment mapping apparatus 120 divides the in-building map data into grids, stores the wireless LAN signals in the respective grids by matching therewith, and assigns identification information to the respective grids in order to distinguish the grids from one another.

The in-building radiowave environment mapping apparatus 120 generates an in-building radiowave environment map by storing the radiowave environment information onto the in-building map data matchingly with every piece of location estimation information for representing the mobile location estimated based on the reference point. The in-building radiowave environment mapping apparatus 120 stores the location estimation information in the in-building map data by matching therewith, stores the received radiowave environment information in the in-building map data by matching therewith, and stores the location estimation information and the radiowave environment information in the in-building map data by matching therewith, based on the reference point.

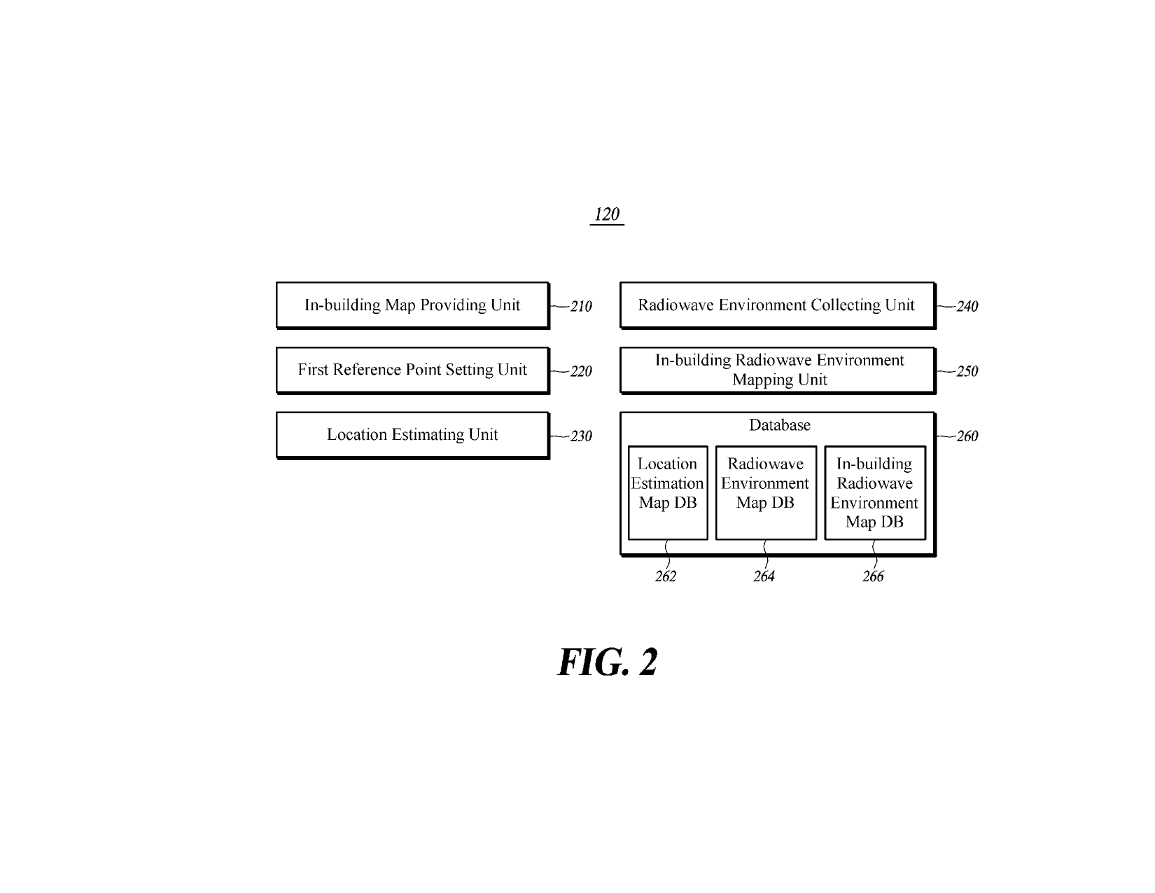

FIG. 2 is a block diagram schematically showing the in-building radiowave environment mapping apparatus according to one embodiment of the present disclosure.

The in-building radiowave environment mapping apparatus 120 according to one embodiment of the present disclosure includes an in-building map providing unit 210, a first reference point setting unit 220, a location estimating unit 230, a radiowave environment collecting unit 240, an in-building radiowave environment mapping unit 250, and a database 260. Meanwhile, the in-building radiowave environment mapping apparatus 120 according to one embodiment of the present disclosure is described as including only the in-building map providing unit 210, the first reference point setting unit 220, the location estimating unit 230, the radiowave environment collecting unit 240, the in-building radiowave environment mapping unit 250, and the database 260, but this is merely an exemplary description about the technical spirit of one embodiment of the present disclosure. It is apparent to those skilled in the art that elements included in the in-building radiowave environment mapping apparatus 120 can be modified and changed in various forms, without departing from essential characteristics of the present disclosure.

The in-building map providing unit 210 provides in-building map data to the radiowave measurement apparatus 110. In addition, the in-building map providing unit 210 extracts an in-building map of a specific location requested by the radiowave measurement apparatus 110 from an in-building map DB, and transmits the extracted in-building map to the radiowave measurement apparatus 110.

The first reference point setting unit 220 interworks with the radiowave measurement apparatus 110 and sets up a reference point of specific area in the in-building map data. In addition, when the radiowave measurement apparatus 110 detects a GPS satellite, the first reference point setting unit 220 sets up current location information, which is obtained based on a GPS radiowave signal received through the GPS satellite, in the in-building map data as the reference point, and transmits the set reference point to the radiowave measurement apparatus 110. That is, the first reference point setting unit 220 mutually matches the reference point on the in-building map data, which is stored in the in-building radiowave environment mapping apparatus 120, and the reference point on the in-building map data, which is stored in the radiowave measurement apparatus 110, as current location information obtained based on the GPS radiowave signal representing the same location information. In addition, the first reference point setting unit 220 sets up location information, which corresponds to a selection signal of specific area received from the radiowave measurement apparatus 110, as the reference point, and sets up the coordinates of the reference point to (0, 0). That is, the first reference point setting unit 220 mutually matches the reference point on the in-building map data in the in-building radiowave environment mapping apparatus 120 and the reference point on the in-building map data in the radiowave measurement apparatus 110, as the location information corresponding to the received selection signal of specific area representing the same location information.

The location estimating unit 230 estimates a mobile location of the radiowave measurement apparatus 110 by using motion sensor information received from the radiowave measurement apparatus 110. In addition, the location estimating unit 230 estimates information on a moving distance and direction per second of the radiowave measurement apparatus 110, based on direction information and/or acceleration information included in the motion sensor information.

The radiowave environment collecting unit 240 collects radiowave environment information from the radiowave measurement apparatus 110. In addition, the radiowave environment collecting unit 240 collects the radiowave environment information, including base station-derived information on base stations with which the radiowave measurement apparatus 110 communicates, from the radiowave measurement apparatus 110. The base station-derived information includes at least one of system ID, network ID, base station ID, base station sector number, received signal strength indicator, signal-to-noise ratio, and phase information. In addition, the radiowave environment collecting unit 240 collects the radiowave environment information, including wireless LAN signals detected by the radiowave measurement apparatus 110, from the radiowave measurement apparatus 110. The wireless LAN signal includes at least one of MAC address of AP relaying the wireless LAN signal, received signal strength (RSS) of each MAC address, AP channel information, and AP frequency information.

The in-building radiowave environment mapping unit 250 generates an in-building radiowave environment map by storing the radiowave environment information onto the in-building map data matchingly with every piece of location estimation information for representing the mobile location estimated based on the reference point. In addition, the in-building radiowave environment mapping unit 250 divides the in-building map data into grids, stores the base station-derived information in the grids by matching therewith, and assigns identification information to the grids in order to distinguish the grids from one another. In addition, the in-building radiowave environment mapping unit 250 divides the in-building map data into grids, stores the wireless LAN signals in the grids by matching therewith, and assigns identification information to the grids in order to distinguish the grids from one another.

The database 260 may include a location estimation map DB 262, a radiowave environment map DB 264, an in-building radiowave environment map DB 266, and an in-building map DB. The location estimation map DB 262 stores the location estimation information in the in-building map data by matching therewith. The radiowave environment map DB 264 stores the received radiowave environment information in the in-building map data by matching therewith. The in-building radiowave environment map DB 266 stores the location estimation information and the radiowave environment information in the in-building map data by matching therewith, based on the reference point. The in-building map DB stores the in-building map data. That is, the database 260 classifies, stores and manages the information related to the in-building radiowave environment map generation. The database 260 may be implemented internally or externally of the in-building radiowave environment mapping apparatus 120. In addition, the database 260 refers to a general data structure implemented in a storage space (hard disk or memory) of a computer system using a database management program (DBM). The database 260 refers to a type of data storage that can freely search (extract), delete, edit and add data. The database 260 may be implemented to achieve the object of one embodiment of the present disclosure by using a relational database management system (RDBMS), such as Oracle, Infomix, Sybase, and DB2, an object-oriented database management system (OODBMS), such as Gemston, Orion, and O2, and an XML native database, such as Excelon, Tamino, and Sekaiju. The database 260 includes appropriate fields or elements so as to achieve its own function.

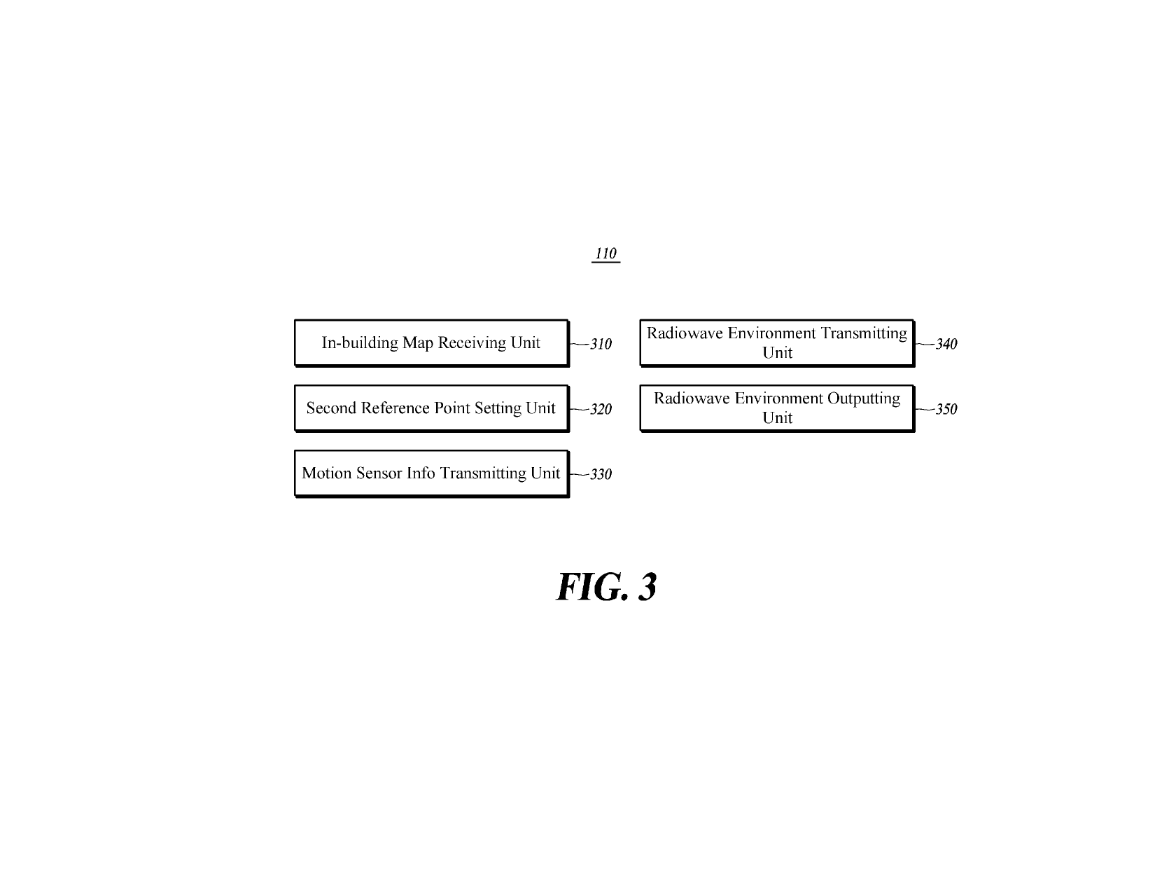

FIG. 3 is a block diagram schematically showing the radiowave measurement apparatus according to one embodiment of the present disclosure.

The radiowave measurement apparatus 110 according to one embodiment of the present disclosure includes an in-building map receiving unit 310, a second reference point setting unit 320, a motion sensor information transmitting unit 330, a radiowave environment transmitting unit 340, and a radiowave environment outputting unit 350. Meanwhile, the radiowave measurement apparatus 110 according to one of many embodiments of the present disclosure is described as including only the in-building map receiving unit 310, the second reference point setting unit 320, the motion sensor information transmitting unit 330, the radiowave environment transmitting unit 340, and the radiowave environment outputting unit 350, but this is merely an exemplary description about the technical spirit of one embodiment of the present disclosure. It is apparent to those skilled in the art that elements included in the radiowave measurement apparatus 110 can be modified and changed in various forms, without departing from essential characteristics of the embodiment of the present disclosure.

The in-building map receiving unit 310 downloads the in-building map data from the in-building radiowave environment mapping apparatus 120 serving as the external server, and installs the downloaded in-building map data.

The second reference point setting unit 320 interworks with the in-building radiowave environment mapping apparatus 120 serving as the external server and sets up a specific area of the in-building map data as a reference point. When a GPS satellite is detected, the second reference point setting unit 320 sets up current location information, which is obtained based on a GPS radiowave signal received from the GPS satellite, in the in-building map data as the reference point, and transmits the set reference point to the in-building radiowave environment mapping apparatus 120 serving as the external server. That is, the second reference point setting unit 320 mutually matches the reference point on the in-building map data, which is stored in the in-building radiowave environment mapping apparatus 120, and the reference point on the in-building map data, which is stored in the radiowave measurement apparatus 110, as current location information obtained based on the GPS radiowave signal representing the same location information. In addition, the second reference point setting unit 320 sets up the location information, which corresponds to a selection signal of specific area, as the reference point having coordinates of (0, 0), and transmits the set reference point to the in-building radiowave environment mapping apparatus 120 serving as the external server. That is, the second reference point setting unit 320 mutually matches the reference point on the in-building map data stored in the in-building radiowave environment mapping apparatus 120 and the reference point on the in-building map data stored in the radiowave measurement apparatus 110, as the location information corresponding to the selection signal of specific area representing the same location information.

The motion sensor information transmitting unit 330 transmits motion sensor information, which is collected by using the motion sensor mounted thereon, to the in-building radiowave environment mapping apparatus 120 serving as the external server. The motion sensor includes at least one module among a gyro sensor, a geomagnetic sensor, a digital compass, and an acceleration sensor. The radiowave environment transmitting unit 340 transmits radiowave environment information, which is collected from adjacent communicating devices, to the in-building radiowave environment mapping apparatus 120. The radiowave environment transmitting unit 340 transmits the radiowave environment information, including wireless base station-derived information and/or LAN signals from the adjacent communicating devices, to the in-building radiowave environment mapping apparatus 120 serving as the external server. The radiowave environment outputting unit 350 overlays the motion sensor information and/or the radiowave environment information on the in-building map data for displaying.

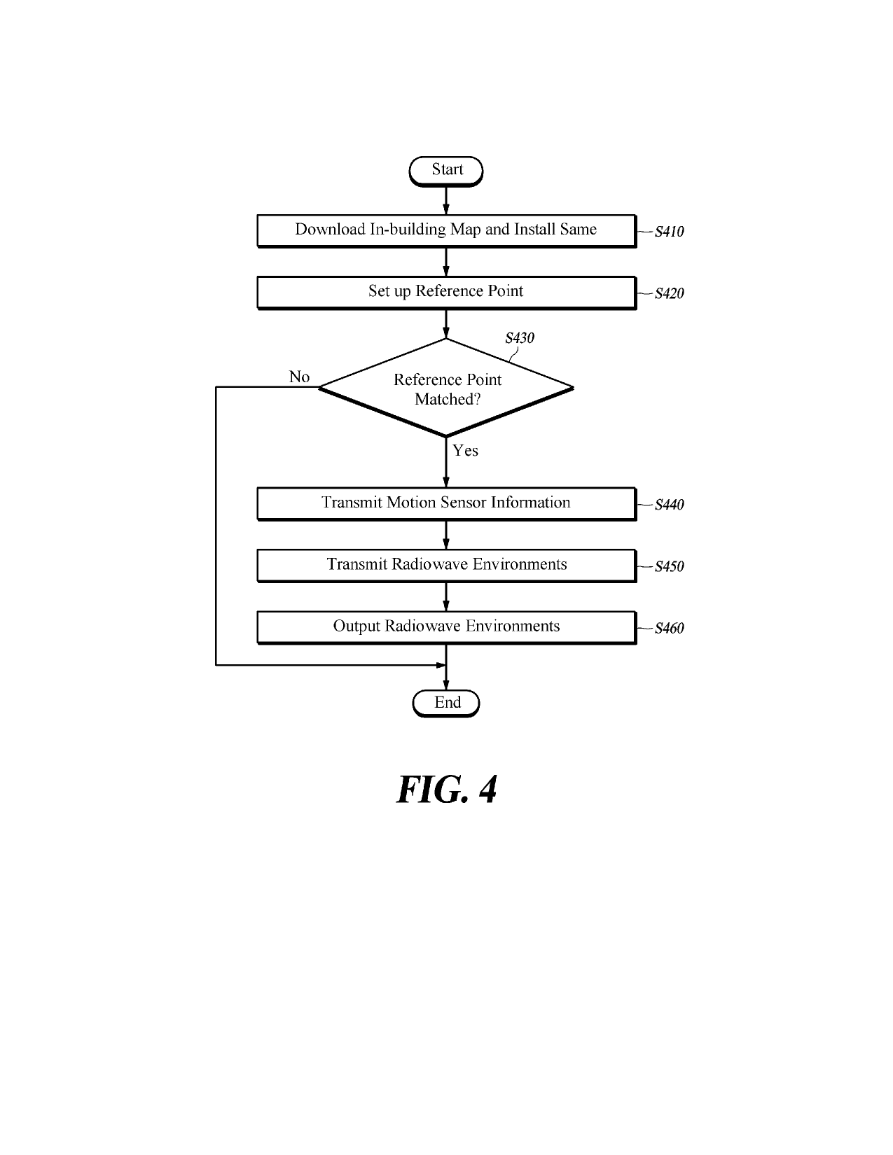

FIG. 4 is a flow chart showing a radiowave environment measurement method according to one embodiment of the present disclosure.

When the radiowave measurement apparatus 110 enters an underground shopping mall or a specific building, the radiowave measurement apparatus 110 requests the in-building radiowave environment mapping apparatus 120 serving as the external server to provide in-building map data of the corresponding location, downloads the in-building map data from the in-building radiowave environment mapping apparatus 120, and installs the downloaded in-building map data (S410). For example, when the radiowave measurement apparatus 110 moves to the first basement level of a new-built ‘A department store’, the radiowave measurement apparatus 110 may request the in-building radiowave environment mapping apparatus 120 to provide the in-building map data corresponding to the first basement of the ‘A department store’, and download the in-building map data.

The radiowave measurement apparatus 110 interworks with the in-building radiowave environment mapping apparatus 120 serving as the external server and sets up a specific area of the in-building map data as a reference point (S420). When a GPS satellite is detected, the radiowave measurement apparatus 110 sets up current location information, which is obtained based on a GPS radiowave signal received from the GPS satellite, in the in-building map data as the reference point, and transmits the set reference point to the in-building radiowave environment mapping apparatus 120 serving as the external server. That is, even with the radiowave measurement apparatus 110 located in-building, for example, the basement or inside of a specific building, the corresponding location information is shared as the reference point if the radiowave measurement apparatus 110 is located in an area where the GPS radiowave signal can be received. That is, the radiowave measurement apparatus 110 mutually matches the reference point on the in-building map data, which is stored in the in-building radiowave environment mapping apparatus 120, and the reference point on the in-building map data, which is stored in the radiowave measurement apparatus 110, as current location information obtained based on the GPS radiowave signal representing the same location information.

Meanwhile, the radiowave measurement apparatus 110 sets up location information, which corresponds to a selection signal of specific area, as the reference point having coordinates of (0, 0), and transmits the set reference point to the in-building radiowave environment mapping apparatus 120 serving as the external server. That is, the radiowave measurement apparatus 110 mutually matches the reference point on the in-building map data stored in the in-building radiowave environment mapping apparatus 120 and the reference point on the in-building map data stored in the radiowave measurement apparatus 110, as the location information corresponding to the selection signal of specific area representing the same location information.

The radiowave measurement apparatus 110 determines whether the reference point on the in-building map data stored in the in-building radiowave environment mapping apparatus 120 and the reference point on the in-building map data stored in the radiowave measurement apparatus 110 are mutually matched as the same location information (S430).

If step S430 determines that the reference point on the in-building map data in the in-building radiowave environment mapping apparatus 120 and the reference point on the in-building map data in the radiowave measurement apparatus 110 are mutually matched as the same location information, the radiowave measurement apparatus 110 transmits the motion sensor information, which is collected by using the motion sensor mounted thereon, to the in-building radiowave environment mapping apparatus 120 serving as the external server (S440). The motion sensor information may be collected by using the motion sensor including at least one module among a gyro sensor, a geomagnetic sensor, a digital compass, and an acceleration sensor in the radiowave measurement apparatus 110. The radiowave measurement apparatus 110 transmits the radiowave environment information, which is received from the adjacent communicating devices, to the in-building radiowave environment mapping apparatus 120 serving as the external server (S450). The radiowave measurement apparatus 110 overlays the motion sensor information and/or the radiowave environment information on the in-building map data for displaying (S460).

Although it has been described that steps S410 to S460 of FIG. 4 are sequentially performed, this is merely an exemplary description about the technical spirit of one embodiment of the present disclosure. It is apparent to those skilled in the art that various modifications and changes can be made thereto, without departing from essential characteristics of one embodiment of the present disclosure. For example, the sequence described in FIG. 4 can be changed, and one or more steps of steps S410 to S460 can be performed in parallel. FIG. 4 is not limited to the temporal order.

The radiowave environment measurement method of FIG. 4 according to one embodiment of the present disclosure may also be embodied as a program on a computer-readable recording medium. The computer-readable recording medium storing the program for realizing the radiowave environment measurement method according to one embodiment of the present disclosure may be any data storage device that can store data which can be thereafter read by a computer system. Examples of the computer-readable recording medium include ROMs, RAMs, CD-ROMs, magnetic tapes, floppy disks, optical data storage devices, and carrier waves (such as data transmission through the Internet). The computer-readable recording medium may also be distributed over network coupled computer systems so that computer-readable codes are stored and executed in a distributed fashion. In addition, functional programs, codes, and code segments for accomplishing one embodiment of the present disclosure may be easily construed by programmers skilled in the art to which the present disclosure pertains.

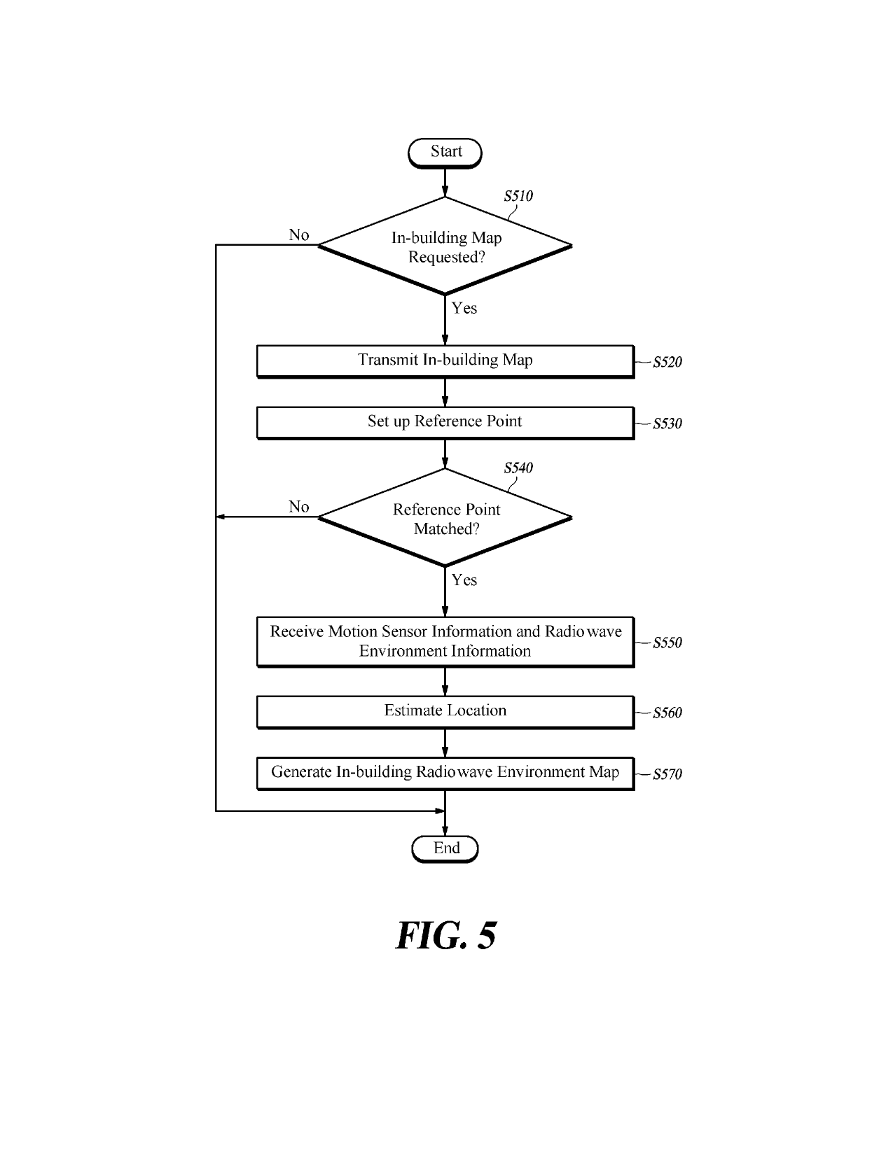

FIG. 5 is a flow chart showing an in-building radiowave environment mapping method according to one embodiment of the present disclosure.

The in-building radiowave environment mapping apparatus 120 determines whether the radiowave measurement apparatus 110 requests in-building map data with respect to a specific location (S510). When it is determined in step S510 that the radiowave measurement apparatus 110 requests the in-building map data of specific location, the in-building radiowave environment mapping apparatus 120 provides the in-building map data to the radiowave measurement apparatus 110 (S510). That is, the in-building radiowave environment mapping apparatus 120 extracts an in-building map of the specific location requested by the radiowave measurement apparatus 110 from an in-building map DB, and transmits the extracted in-building map to the radiowave measurement apparatus 110.

The in-building radiowave environment mapping apparatus 120 interworks with the radiowave measurement apparatus 110 and sets up a reference point of specific area in the in-building map data (S530). Step S530 will be described below in more detail. When the radiowave measurement apparatus 110 detects a GPS satellite, the in-building radiowave environment mapping apparatus 120 sets up current location information, which is obtained based on a GPS radiowave signal received through the GPS satellite, in the in-building map data as the reference point, and transmits the set reference point to the radiowave measurement apparatus 110. That is, the reference point on the in-building map data, which is stored in the in-building radiowave environment mapping apparatus 120, and the reference point on the in-building map data, which is stored in the radiowave measurement apparatus 110, are mutually matched as current location information obtained based on the GPS radiowave signal representing the same location information. Meanwhile, the in-building radiowave environment mapping apparatus 120 sets up location information, which corresponds to a selection signal of specific area received from the radiowave measurement apparatus 110, as the reference point, and sets up the coordinates of the reference point to (0, 0). That is, the reference point on the in-building map data stored in the in-building radiowave environment mapping apparatus 120 and the reference point on the in-building map data stored in the radiowave measurement apparatus 110 are mutually matched as the location information corresponding to the received selection signal of specific area representing the same location information.

The in-building radiowave environment mapping apparatus 120 determines whether the reference point on the in-building map data stored in the in-building radiowave environment mapping apparatus 120 and the reference point on the in-building map data stored in the radiowave measurement apparatus 110 are mutually matched as the same location information (S540). If step S540 determines that the reference point on the in-building map data stored in the in-building radiowave environment mapping apparatus 120 and the reference point on the in-building map data stored in the radiowave measurement apparatus 110 are mutually matched as the same location information, the in-building radiowave environment mapping apparatus 120 receives motion sensor information and radiowave environment information from the radiowave measurement apparatus 110 (S550). That is, the in-building radiowave environment mapping apparatus 120 collects radiowave environment information, including base station-derived information on base stations with which the radiowave measurement apparatus 110 communicates, from the radiowave measurement apparatus 110. The base station-derived information includes at least one of system ID, network ID, base station ID, base station sector number, received signal strength indicator, signal-to-noise ratio, and phase information. In addition, the in-building radiowave environment mapping apparatus 120 collects radiowave environment information, including wireless LAN signals detected by the radiowave measurement apparatus 110, from the radiowave measurement apparatus 110. The wireless LAN signal includes at least one of MAC address of AP relaying the wireless LAN signal, received signal strength (RSS) of each MAC address, AP channel information, and AP frequency information.

The in-building radiowave environment mapping apparatus 120 generates location estimation information by estimating a mobile location of the radiowave measurement apparatus 110 by using the motion sensor information received from the radiowave measurement apparatus 110 (S560). That is, the in-building radiowave environment mapping apparatus 120 estimates information on a moving distance and direction per second of the radiowave measurement apparatus 110 based on direction information and/or acceleration information included in the motion sensor information.

The in-building radiowave environment mapping apparatus 120 generates an in-building radiowave environment map by storing the radiowave environment information onto the in-building map data matchingly with every piece of the location estimation information on the mobile location estimated based on the reference point (S570). The in-building radiowave environment mapping apparatus 120 may store the location estimation information in the in-building map data by matching therewith, store the received radiowave environment information in the in-building map data by matching therewith, and store the location estimation information and the radiowave environment information in the in-building map data by matching therewith. Meanwhile, the in-building radiowave environment mapping apparatus 120 may divide the in-building map data into grids, store the base station-derived information and/or the wireless LAN information in the grids by matching therewith, and assign identification information to the grids in order to distinguish the grids from one another.

Although it has been described that steps S510 to S570 of FIG. 5 are sequentially performed, this is merely an exemplary description about the technical spirit of one of many embodiments of the present disclosure. It is apparent to those skilled in the art that various modifications and changes can be made thereto, without departing from essential characteristics of one embodiment of the present disclosure. For example, the sequence described in FIG. 5 can be changed, and one or more steps of steps S510 to S570 can be performed in parallel. FIG. 5 is not limited to the temporal order.

The in-building radiowave environment mapping method of FIG. 5 according to one embodiment of the present disclosure may also be embodied as a program on a computer-readable recording medium. The computer-readable recording medium storing the program for realizing the in-building radiowave environment mapping method according to one embodiment of the present disclosure may be any data storage device that can store data which can be thereafter read by a computer system. Examples of the computer-readable recording medium include ROMs, RAMs, CD-ROMs, magnetic tapes, floppy disks, optical data storage devices, and carrier waves (such as data transmission through the Internet). The computer-readable recording medium may also be distributed over network coupled computer systems so that computer-readable codes are stored and executed in a distributed fashion. In addition, functional programs, codes, and code segments for accomplishing one embodiment of the present disclosure may be easily construed by programmers skilled in the art to which the present disclosure pertains.

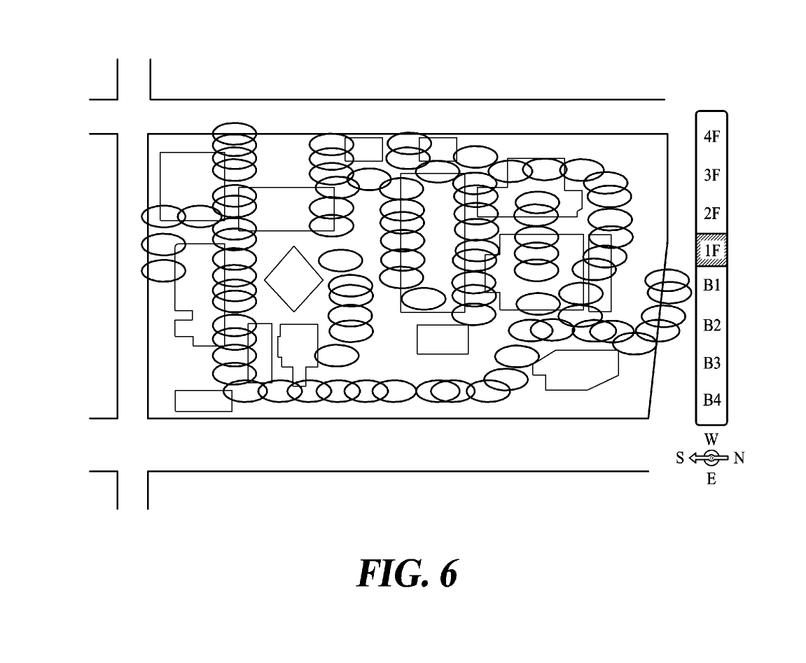

FIG. 6 is an exemplary diagram of the in-building radiowave environment map according to one embodiment of the present disclosure.

As shown in FIG. 6, the in-building radiowave environment mapping apparatus 120 generates the in-building radiowave environment map by storing the radiowave environment information onto the in-building map data matchingly with every piece of the location estimation information on the mobile location estimated based on the reference point. That is, as shown in FIG. 6, the radiowave measurement apparatus 110 receives, matches and stores the radiowave environment information for every piece of traveled location estimation information onto the in-building map data. Meanwhile, the radiowave measurement apparatus 110 transmits the radiowave environment information, including the base station-derived information and/or the wireless LAN signals from the adjacent communicating devices, to the in-building radiowave environment mapping apparatus 120 serving as the external server. Then, as shown in FIG. 6, the motion sensor information and/or the radiowave environment information may be overlaid on the in-building map data for displaying in the radiowave measurement apparatus 110.

The following exemplary implementation is considered to have a higher demand of application of the in-building radiowave environment map according to one embodiment of the present disclosure. After generating the in-building radiowave environment map through the in-building radiowave environment mapping apparatus 120, a location determination service using the in-building radiowave environment map may also be provided. In particular, when a user requests a positioning service in an in-building area, a location calculation server may determine a user location by using the in-building radiowave environment map generated by the in-building radiowave environment mapping apparatus 120, and transmit the determined user location to a user terminal. That is, the location calculation server may select locations matched with the radiowave environment information received from the terminal in the in-building radiowave environment map, and use a triangulation method with respect to the selected locations. In addition, the user terminal may interwork with an augmented reality server and overlay the corresponding locations in a Points of Interest (P01) form for displaying on an image obtained by the terminal. In addition, the in-building radiowave environment mapping apparatus 120 may automatically generate an in-building radiowave environment map for a relevant area by connecting to a robot mounted with an algorithm that can avoid an obstacle by using an infrared sensor or can uniformly measure an entire area. Moreover, in the large shopping malls, the in-building radiowave environment mapping apparatus 120 may be connected to users' carts. In this case, the in-building radiowave environment mapping apparatus 120 may generate the in-building radiowave environment map following the moving paths of the users, and transmit the in-building radiowave environment map to the in-building radiowave environment mapping apparatus 120 periodically.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure deals with lack of in-building radiowave environment maps in new-built buildings or underground shopping malls by estimating mobile location using a radiowave measurement device mounted with a motion sensor, and generating in-building radiowave environment maps matched with radiowave environment characteristics at every estimated location, thereby generating a more accurate in-building radiowave environment map.

### CROSS-REFERENCE TO RELATED APPLICATION

If applicable, this application claims priority under 35 U.S.C. §119(a) of Patent Application No. 10-2010-0060674, filed on Jun. 25, 2010 in Korea, the entire content of which is incorporated herein by reference. In addition, this non-provisional application claims priority in countries, other than the U.S., with the same reason based on the Korean Patent Application, the entire content of which is hereby incorporated by reference.

1. An apparatus for generating in-building radiowave environment maps, comprising:
an in-building map providing unit configured to provide in-building map data to a radiowave measurement device;
a reference point setting unit configured to interwork with the radiowave measurement device and set up a reference point of specific area in the in-building map data;
a location estimating unit configured to estimate a mobile location of the radiowave measurement device by using motion sensor information received from the radiowave measurement device;
a radiowave environment collecting unit configured to collect radiowave environment information from the radiowave measurement device; and
an in-building radiowave environment mapping unit configured to generate an in-building radiowave environment map by storing the radiowave environment information onto the in-building map data matchingly with every piece of location estimation information for representing the mobile location estimated based on the reference point.

2. The apparatus of claim 1, wherein when the radiowave measurement device detects a GPS satellite, the reference point setting unit sets up current location information, which is obtained based on a GPS radiowave signal received through the GPS satellite, in the in-building map data as the reference point, and transmits the set reference point to the radiowave measurement device.

3. The apparatus of claim 1, wherein the reference point setting unit sets up location information, which corresponds to a selection signal of specific area received from the radiowave measurement device, as the reference point, and sets up coordinates of the reference point to (0, 0).

4. The apparatus of claim 1, wherein the radiowave environment collecting unit collects the radiowave environment information, including base station-derived information on base stations with which the radiowave measurement device communicates, from the radiowave measurement device.

5. The apparatus of claim 4, wherein the base station-derived information includes at least one of system ID (SID), network ID (NID), base station ID (BSID), base station sector number (Ref_PN: reference PN), received signal strength indicator (RSSI), signal-to-noise ratio (Ec/lo), and phase information.

6. The apparatus of claim 4, wherein the in-building radiowave environment mapping unit divides the in-building map data into grids, stores the base station-derived information matchingly into the grids, and assigns identification information to the grids in order to distinguish the grids from one another.

7. The apparatus of claim 1, wherein the radiowave environment collecting unit collects the radiowave environment information, including a wireless LAN signal detected by the radiowave measurement device, from the radiowave measurement device.

8. The apparatus of claim 7, wherein the wireless LAN signal includes one or more of MAC address of access point (AP) relaying the wireless LAN signal, received signal strength (RSS) of each MAC address, AP channel information, and AP frequency information.

9. The apparatus of claim 7, wherein the in-building radiowave environment mapping unit divides the in-building map data into grids, stores the wireless LAN signal matchingly into the grids, and assigns identification information to the grids in order to distinguish the grids from one another.

10. The apparatus of claim 1, wherein the location estimating unit estimates information on a moving distance of the radiowave measurement device per second and information on a direction of the radiowave measurement device, based on one or more of direction information and acceleration information included in the motion sensor information.

11. The apparatus of claim 1, wherein the in-building map providing unit extracts an in-building map of a specific location requested by the radiowave measurement device from an in-building map database, and transmits an extracted in-building map to the radiowave measurement device.

12. The apparatus of claim 1, further comprising a database which includes:
a location estimation map database for storing the location estimation information matchingly into the in-building map data;
a radiowave environment map database for storing the radiowave environment information having been received matchingly into the in-building map data; and
an in-building radiowave environment map database for storing the location estimation information and the radiowave environment information matchingly into the in-building map data based on the reference point.

13. A method for generating in-building radiowave environment maps, comprising:
providing in-building map data to a radiowave measurement device;
interworking with the radiowave measurement device and setting up a reference point of specific area in the in-building map data;
estimating a mobile location of the radiowave measurement device by using motion sensor information received from the radiowave measurement device;
collecting radiowave environment information from the radiowave measurement device; and
generating an in-building radiowave environment map by storing the radiowave environment information onto the in-building map data matchingly with every piece of location estimation information for representing the mobile location estimated based on the reference point.
